(19) United States
(12) Patent Application Publication
(10) Pub. No.: US 2008/0092417 A1
(43) Pub. Date: Apr. 24, 2008

(54) Three-dimensional diorama display system

(76) Inventors: Christopher S. Crowell, Lyme, CT (US); Joseph R. Klim, New Britain, CT (US)

Correspondence Address: Melvin L. Stoltz, 51 Cherry Street, Milford, CT, 06460, US

(21) Appl. No.: 11/654,469

(22) Filed: Jan. 17, 2007

Related U.S. Application Data
(60) Provisional application No. 60/764,296, filed on Feb. 1, 2006.

(51) Int. Cl. G09F 1/00

(52) U.S. Cl. 40/124.07

(57) ABSTRACT

By providing a unique, pre-formed holding member which is quickly and easily assembled into the three-dimensional diorama display, a unique, visually exciting and interest generating three-dimensional diorama display system is attained. In the preferred embodiment of the present invention, a substantially flat transparent sheet of material is constructed having a desired size and shape for receiving and holding a particular photograph construction or configuration. In addition, the transparent sheet of material incorporates cooperating preformed score lines formed along the opposed edges of the transparent sheet, effectively establishing flanges at the opposed side edges thereof. Each of the flanges are arcuately pivoted along the associated score lines, thereby enabling the flanges to extend inwardly, towards each other, establishing two cooperating photograph edge holding flanges.

### RELATED APPLICATIONS

This application is related to U.S. Provisional Patent Application Ser. No. 60/764,296, filed Feb. 1, 2006 entitled THREE DIMENSIONAL DIORAMA DISPLAY SYSTEM.

### TECHNICAL FIELD

This invention relates to three-dimensional diorama display systems and, more particularly, to such products which enable the user to create a three dimensional diorama display system from a two-dimensional, substantially flat configuration.

### BACKGROUND ART

With the ever increasing and widening interests of consumers and the variety of products which consumers wish to purchase, manufacturers have sought to provide competitive products which will satisfy consumers' interests and desires. In this regard, inexpensive or reasonably priced display systems have long been an area of interest for consumers, particularly those display systems which provide appealing, visually exciting and interest generating images, in particular, display system which are able to employ personal photographs of the consumer.

In an attempt to meet and satisfy consumers' desires, numerous pop-up displays, greeting cards, display cards, and dioramas have been offered for sale in a wide variety of alternate configurations and appearances. However, in spite of the effort expended by many companies to satisfy consumer interests, these prior art products have generally failed to provide the desired interest generating results, in a reasonably priced consumer product. Typically, these prior art products employ complex systems which produce three-dimensional displays when unfolded or erected. However, in spite of some visually unique appearances being generated by such products, the overall cost of production and complexity of assembly for these systems have prevented the systems from becoming popular and/or saleable.

Other prior art display systems have attempted to generate consumer interest by providing unique visual images or other indicia as an integral part of a display. However, these prior art attempts have also failed to generate the interest being sought, largely due to an inability to achieve an easily erected and employable product.

Therefore, it is a principal object of the present invention to provide a visually attractive, interest generating display system which is capable of being produced at a reasonable cost and provides an exciting, visually stimulating display.

Another object of the present invention is to provide a visually attractive, interest generating display system having the characteristic features described above which is in the form of a self-erecting diorama, which is quickly and easily employed by the consumer.

Another object to the present invention is to provide a visually attractive, interest generating diorama display system having the characteristic features described above which is capable of mass production and assembly.

Another object of the present invention is to provide a visually attractive, interest generating diorama display system having the characteristic features described above which provides a unique, eye-catching and exciting display which can be widely varied for satisfying diverse consumer interests.

Another object to the present invention is to provide a visually attractive, interest generating diorama display system having the characteristic features described above which is shippable and transportable in a completely flat configuration, while being quickly erectable, whenever desired, into the three-dimensional visually attractive diorama display.

Another object to the present invention is to provide a visually attractive, interest generating diorama display system having the characteristic features described above which employs personal photographs that are easily mounted as an integral part of the display.

Other and more specific objects will in part be obvious and will in part appear hereinafter.

### SUMMARY OF THE INVENTION

By employing the present invention, all of the difficulties and inabilities of the prior art are eliminated and a unique, visually exciting and interest generating three-dimensional diorama display system is attained. These desirable results are achieved in the present invention by providing a unique, pre-formed holding member which is quickly and easily assembled into the three-dimensional diorama display. In addition, the holding member is shipped or stored in a substantially flat configuration in order to reduce storage space. Furthermore, in accordance with the unique aspects of the present invention, the interest generating, three-dimensional/diorama display system of the present invention is quickly and easily fully erected from its flat, generally two-dimensional configuration into a three-dimensional diorama display, possessing all of the attributes desired by consumers.

In accordance with the present invention, a holding member is provided which is constructed for being quickly and easily converted from a two-dimensional, substantially flat configuration into a three-dimensional, fully erect, fully assembled, interest generating, visually exciting diorama displaying position which incorporates any photograph desired by the consumer to be displayed. Although prior art constructions exist for various diorama displays, the present invention provides a unique construction which achieves a quickly and easily constructed three-dimensional diorama display which enables the consumer to display any desired photograph in a unique, interest generating and visually exciting manner.

In accordance with the present invention, a substantially flat transparent sheet of material is constructed having a desired size and shape for receiving and holding a particular photograph construction or configuration. In addition, the transparent sheet of material incorporates cooperating pre-formed score lines formed along the opposed edges of the transparent sheet, effectively establishing flanges at the opposed side edges thereof. Whenever desired by the consumer, each of the flanges are arcuately pivoted along the associated score lines, thereby enabling the flanges to extend inwardly, towards each other, establishing two cooperating photograph edge holding flanges.

Once constructed in this simple, straightforward manner, the holding member of the present invention is ready to receive any desired photograph which the consumer wishes to display. In accordance with the teaching of the present invention, the size and shape of the holding member is designed to enable the photograph to be quickly and easily inserted into the holding engagement with the holding member in a manner which requires the photograph to be arcuately curved and extending rearwardly from the holding member. In this way, a three-dimensional visual effect is achieved.

By constructing the holding member of the present invention in a wide variety of alternate sizes and shapes, all photograph constructions and configurations can be easily accommodated. In this way, each desired photograph can be quickly and easily inserted into an appropriate holding member for achieving a visually distinctive, eye-catching, and interest generating three-dimensional display of the desired photograph.

In order to further enhance the unique, visual display provided by the present invention, various pre-formed, die cut elements may be associated with the holding member. In this regard, preprinted, preformed frame assemblies or die cut, preprinted scene oriented accent strips can be mounted directly on the holding member or in cooperating association with the photograph when secured to the holding member. Regardless of the system employed, these preformed, preprinted accent elements can be employed for providing further enhancement to any desired photograph, thereby increasing the interest and visual excitement provided thereby.

The invention accordingly comprises an article of manufacture possessing the features, properties, and relation of elements which will be exemplified in the article hereinafter described, and the scope of the invention will be indicated in the claims.

### THE DRAWINGS

For a fuller understanding of the nature and objects of the present invention, reference should be had to the following detailed description taken in connection with the accompanying drawings, in which:

FIG. 1 is a top plan view of the pre-formed holding member of the present invention shown in its substantially flat, two-dimensional position;

FIG. 2 is a top plan view of the preformed holding member of FIG. 1 shown in the process of being formed into its three-dimensional display position;

FIG. 3 is a top plan view of the preformed holding member of FIG. 1 shown in its final, three-dimensional display position;

FIGS. 4-7 are various views of the preformed holding member of FIG. 1 depicting the process of assembly with a photograph being inserted therewith;

FIGS. 8-10 are perspective views of the preformed holding member of FIG. 1 shown fully assembled with additional enhancing elements cooperatively associated therewith; and

FIG. 11 is a rear plan view of an alternate embodiment of the preformed holding member of the present invention.

### DETAILED DISCLOSURE

By referring to FIGS. 1-11, along with the following detailed discussion, the construction and operation of several preferred alternate embodiments of the present invention can best be understood. In addition, further alternate embodiments or constructions can be implemented using the teaching of the present invention. Consequently, it is to be understood that the following detailed disclosure and the specific embodiments shown herein, are provided for exemplary purposes only and are not intended as a limitation of the present invention.

In FIGS. 1-3, picture or photograph holding, three-dimensional/diorama forming display system 20 is fully depicted. As shown, display system 20 comprises panel 21, which is formed from a substantially flat piece of transparent material and comprises side edges 22 and 23, top edge 24, and bottom edge 25. In addition, panel 21 incorporates score lines 26 and 27 which are formed in panel 21, spaced inwardly from side edges 22 and 23. As detailed herein, holding flanges 28 and 29 are formed by score lines 26 and 27, with flanges 28 being formed between side edge 22 and score line 26, while flange 29 is formed between side edge 23 and score line 27.

In FIG. 1, picture/photograph holding, three-dimensional/diorama forming display system 20 is shown in its substantially flat two-dimensional configuration, prior to assembly. In this position, display system 20 is substantially flat, and is easily stored wherever desired. However, whenever display system 20 is ready to be employed for providing the visually exciting, eye-catching display attainable therewith, display system 20 is removed from any container and the user merely arcuately pivots flange 28 about score line 26. Similarly, flange 29 is arcuately pivoted about score line 27.

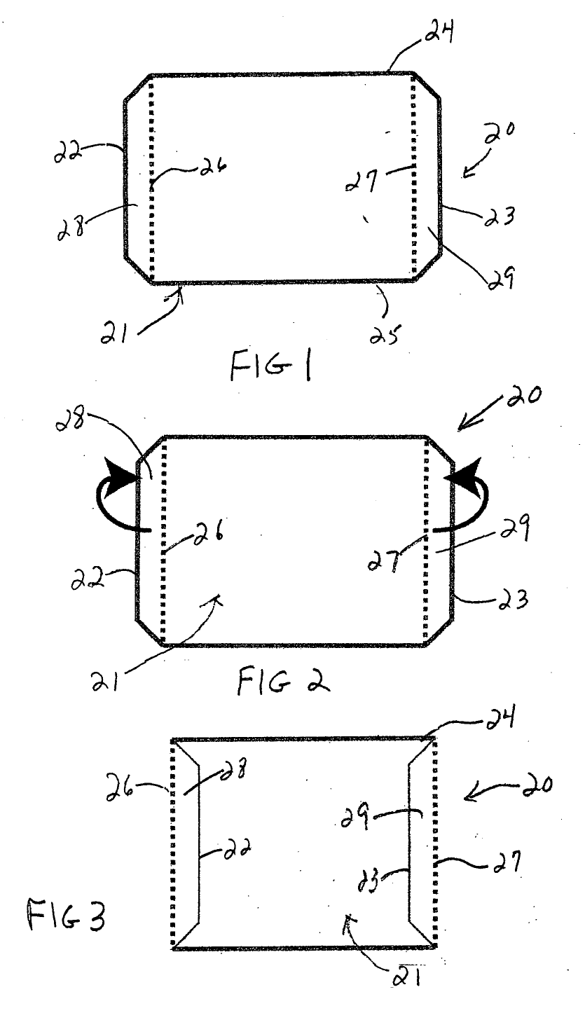

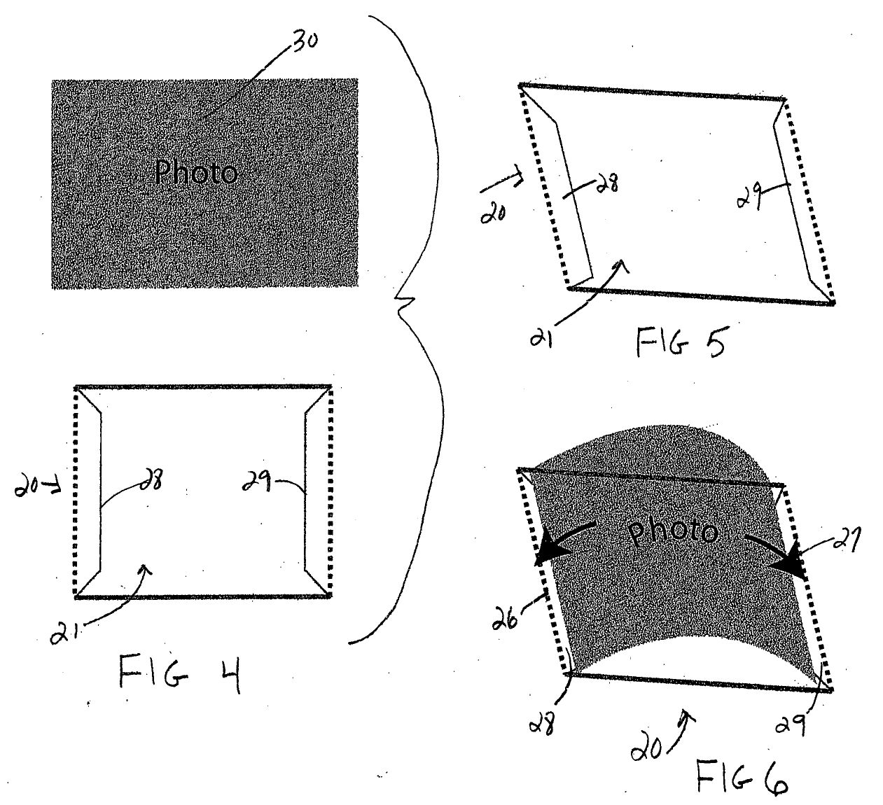

When completed, holding flanges 28 and 29 are turned inwardly relative to score lines 26 and 27, positioned as shown in FIG. 3. In this position, side edges 22 and 23 are generally facing each other, with flanges 28 and 29 extending outwardly from the central body of panel 21 and with score lines 26 and 27 forming the side edges of display system 20. In general, flanges 28 and 29 preferably extend from panel 21 at an angle ranging between about 10° and 90°, with 45° being preferred.

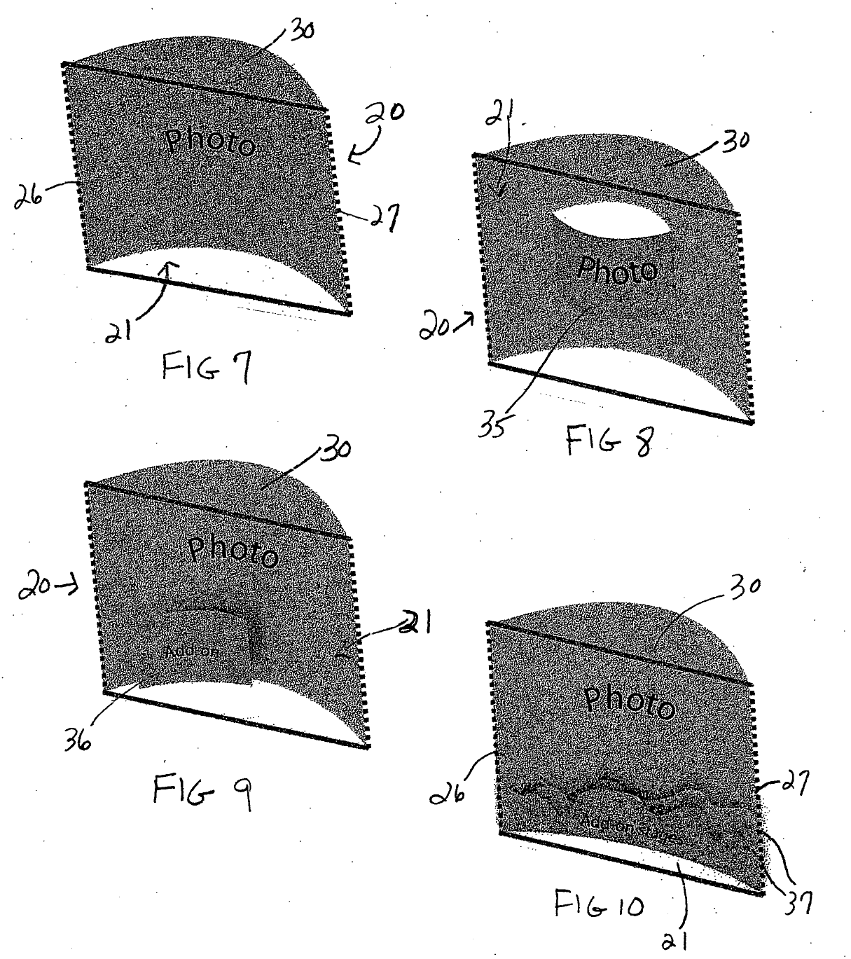

As clearly shown in FIGS. 4-7, once picture/photograph holding, three-dimensional/diorama forming display system 20 has been formed in the desired configuration with flanges 28 and 29 extending inwardly from the body of panel 21, flanges 28 and 29 are capable of being employed for quickly and easily securely retaining the side edges of any picture or photograph. As depicted, any desired photograph 30 is arcuately curved with the side edges thereof being advanced into holding engagement with flanges 28 and 29 and score lines 26 and 27. Once this quick, simple, easily achieved procedure has been implemented, the resulting three-dimensional/diorama forming display system 20 is realized as shown in FIG. 7.

As is evident from the foregoing detailed discussion, picture/photograph holding, three-dimensional/diorama forming display system 20 of the present invention is quickly and easily constructed from its completely flat, two-dimensional configuration into its three-dimensional diorama displaying position. In addition, any desired picture or photograph is quickly and easily inserted into secure holding engagement with display system 20, enabling the photograph or picture to be retained in a continuous, arcuately curved configuration, enabling the picture to be viewable in a unique, eye-catching, interest generating, three-dimensional display. As a result, a simple and inexpensive three-dimensional display system is realized which prior art systems have been incapable of attaining.

By referring to FIGS. 8-10, further enhancements or unique distinctive visual add-ons can be employed in order to enhance the eye-catching, visual stimulation attainable by display system 20 of the present invention. As shown therein, for exemplary purposes only, various pre-printed die-cut elements or cut out sections can be added to the photograph or incorporated into the display system in order to provide desired visual enhancements.

In FIG. 8, photograph 30 is shown mounted in display system 20 in its three-dimensional/diorama forming configuration, with cut out portion 35 formed therein and pushed forward of the arcuate curved surface of photograph 30. As a result, portion 35 extends forwardly of the visual information contained on photograph 30, thereby providing a unique and distinctive visual impression.

In FIG. 9, a separate and independent add-on, cutout element 36 is shown positioned between panel 21 and photograph 33. In the embodiment depicted, add-on element 36 is glued to photograph 30. However, element 36 can be affixed to panel 21 or mounted in the open zone formed between the surfaces of photograph 30 and panel 21. Regardless of the configuration employed, virtually any desired unique, distinctive, eye-catching, visual configurations can be implemented and easily attained using these features.

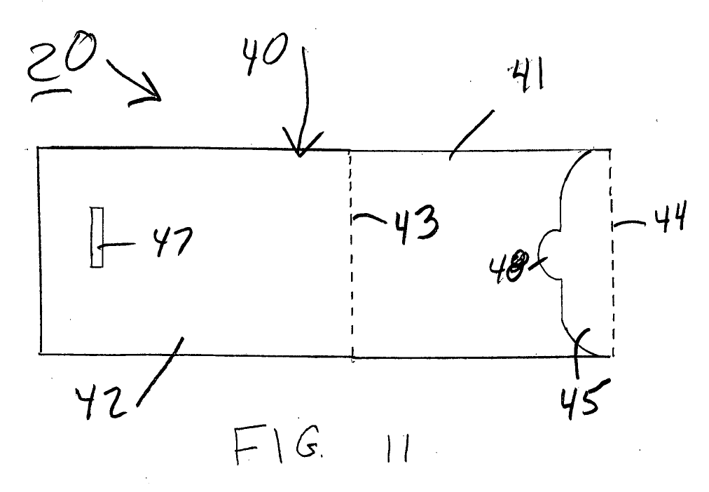

Finally, in FIG. 10, photograph 30 is shown mounted in display system 20 in its three-dimensional/diorama forming configuration, with a plurality of additional scene enhancing cutout elements 37 mounted between photograph 30 and panel 21. As depicted, scene enhancing cutout elements 37 extend from score line 26 to score line 27, and are held in position by flanges 28 and 29, similar to the holding engagement of photograph 30. If desired, scene enhancing cut out elements 37 may be affixed to the surface of panel 21, the surface of photograph 30, or maintained in sandwiched interengagement in the manner depicted. Furthermore, if desired, scene enhancing cut out elements 37 may be formed in a peripherally surrounding frame or other configuration for providing any desired background or picture enhancing features to three-dimensional diorama display achieved by the present convention.

In FIG. 11, a further alternate embodiment of picture/photograph holding, three-dimensional/diorama forming display system 20 is depicted. In this embodiment, display system 20 incorporates a single, elongated panel member 40 which is maintained in a substantially flat, two-dimensional configuration prior to assembly.

In the preferred construction, panel member 40 comprises first section 41 and second section 42 which are formed adjacent to each other, separated by score line 43. In addition, panel 40 also incorporates score line 44 which is employed for forming flange 45 and enables flange 45 to be easily moved from a substantially flat configuration into an operational position wherein flange 45 extends outwardly from the surface of section 41. Finally, panel member 40 is preferably constructed from transparent, plastic material having some inherent rigidity, as well as flexibility.

In the preferred construction of this embodiment of the present invention, section 42 of panel member 40 comprises an overall length substantially greater than the overall length of section 41. In addition, receiving slot 47 is formed adjacent to the terminating edge of panel 42 in position for receiving and enabling tab 48 of flange 45 to be inserted and retained therein.

By employing this embodiment of the present invention, display system 20 is quickly and easily erected by arcuately pivoting panel 42 relative to panel 41 along score line 43 and engaging tab 48 in slot 47 of panel 42 in order to retain panel 42 in its curved configuration. Once the assembly is completed, panel 41 remains substantially flat, while panel 42 is arcuately curved extending from score line 43 to flange 44.

Once completely assembled, any desired photograph can be affixed to panel 42 or inserted and retained in display system 20 by placing the edges of the photograph in contact with score lines 43 and 44. In addition, if desired, any visual add-ons or enhancements can also be constructed in the manner detailed above and mounted in panel 40 in association with the photograph for providing further visual interest, excitement, and/or stimulation. In this way, a further unique, distinctive, and easily constructed diorama display system is achieved which is visually attractive and capable of generating interest and excitement.

As is evident from the foregoing detailed discussion, a uniquely constructed, simple and inexpensive three-dimensional/diorama forming display system is attained by employing the teaching of this invention. As shown and discussed, any desired photograph can be quickly and easily substantially enhanced for producing a unique, visually distinctive eye-catching three-dimensional/diorama display which has previously been unattainable with any prior art system. Furthermore, by employing any of the unique add-ons or enhancements detailed above, further visually distinctive features are realized.

It will thus be seen that the objects set forth above, among those made apparent from the preceding description, are efficiently attained and, since certain changes may be made in the above article without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described our invention, what we claim is new and desire to secure by Letters Patent is:

1. A display system for providing an attractive and interest generating visual display comprising a holding member constructed for maintaining any desired picture or drawing in an arcuately curved, diorama display, said holding member comprising:
A. a substantially flat, transparent panel incorporating a first side edge and a second, opposed side edge;
B. a first flange element formed along the first side edge of said panel and extending therefrom for receiving and holding a first edge of the desired picture/drawing; and
C. a second flange element formed along the second edge of the said panel and extending therefrom for receiving and holding a second edge of the desired picture/drawing;
whereby an easily constructed display system is achieved which is capable of being easily erected for attractively displaying any desired picture or drawing in an arcuately curved configuration.

2. The display system defined in claim 1, wherein the spaced distance between the first flange element and the second flange element is less than the overall length of the desired picture/drawing to be displayed, thereby assuring the arcuately curved display of said picture/drawing.

3. The display system defined in claim 2, wherein the first flange element and the second flange element each extend along substantially the entire width of the side edge of the panel.

4. The display system defined in claim 3, wherein each of the flange elements are further defined as extending outwardly from the panel at an arcuate distance from the panel ranging between about 10° and 90°.

5. The display system defined in claim 4, wherein each of the flange elements are further defined as extending outwardly from the panel at an arcuate distance of about 45°.

6. The display system defined in claim 2, wherein each of the flange elements are further defined as being formed integrally with the panel along the side edges thereof.

7. The display system defined in claim 6, wherein each of the flange elements are further defined as being formed by scoring the panel along a desired location on the panel and folding the panel along the score lines for forming the flange elements.

8. The display system defined in claim 2, wherein said system further comprises:
D. at least one display enhancing member constructed for being positioned between the picture/drawing and the panel and being held in the desired position by the first and second flange elements.

9. The display system defined in claim 8, wherein said display enhancing member is further defined as comprising an overall length substantially equivalent to the spaced distance between the first flange element and the second flange element.

10. The display system defined in claim 9, wherein said display enhancing member comprises a vertical height which is equal to or less than 30% of the vertical height of the picture/drawing.

11. The display system defined in claim 8, wherein said display enhancing member comprises indicia formed thereon.

12. The display system defined in claim 11, wherein said indicia is further defined as comprising one or more selected from the group consisting of pictures, alphanumeric elements, colors, logos, contours and cutouts.

13. The display system defined in claim 8, wherein the display enhancing member is further defined as comprising a size and shape generally equivalent to the picture/drawing being retained, with the display enhancing member incorporating an enlarged opening formed therein for enabling a majority of the picture/drawing to be seen through the display enhancing member.

14. The display system defined in claim 13, wherein said enlarged opening is formed in a generally rectangular shape.

15. A display system for providing an attractive and interest generating visual display comprising a holding member constructed for maintaining any desired picture or drawing in an arcuately curved, diorama display, said holding member comprising an elongated, substantially flat, transparent sheet of material incorporating a first elongated panel having a first length and a second elongated panel having a second length, said second length being greater than the first length, said first panel and said second panel being mounted to each other along a common fold line, and said first elongated panel also comprising a flange element formed on the edge thereof opposed to the fold line, whereby said display system is quickly and easily erected by placing the first panel in a substantially flat elongated configuration with the second panel extending from the fold line in an arcuately curved configuration with its terminating end engaged with the flange of the first panel, whereby an easily constructed display system is achieved which is easily erected and provides a picture retaining display system for holding the picture/drawing in an arcuately curved diorama configuration.

16. The display system defined in claim 15, wherein said holding system is constructed from a continuous piece of transparent plastic material preformed into the desired shape.
